(19) United States
(12) Patent Application Publication
(10) Pub. No.: US 2024/0109454 A1
(43) Pub. Date: Apr. 4, 2024

(54) VEHICLE CHARGING SYSTEM

(71) Applicant: Rivian IP Holdings, LLC, Plymouth, MI (US)

(72) Inventor: Tyler Jennings Bennett, Long Beach, CA (US)

(73) Assignee: Rivian IP Holdings, LLC, Plymouth, MI (US)

(21) Appl. No.: 17/956,108

(22) Filed: Sep. 29, 2022

(51) Int. Cl. B60L 53/68; B60L 53/66; G06Q 10/06; G06Q 50/06

(52) U.S. Cl. CPC B60L 53/68; B60L 53/66; G06Q 10/06315; G06Q 50/06

(57) ABSTRACT

Disclosed are systems and methods for vehicle charging. The system can include a data processing system. The data processing system can include one or more processors, coupled with memory, to receive data indicating a characteristic of a vehicle. The data processing system can determine, based on at least the characteristic of the vehicle, a length of time to charge the vehicle at a first dispenser and a length of time to charge the vehicle at a second dispenser. The data processing system can assign the vehicle to the first dispenser based on the length of time to charge the vehicle at the first dispenser and the length of time to charge the vehicle at the second dispenser. The data processing system can transmit the assignment of the vehicle to the first dispenser to the vehicle.

### INTRODUCTION

A vehicle, such as an electric vehicle, can be powered by batteries. The vehicle can include components that operate the vehicle based on power provided by the batteries.

### SUMMARY

The system described herein can include a data processing system that efficiently assigns vehicles to dispensers of at least one charging station to reduce a total time to charge the vehicles. The data processing system can integrate with vehicles and charging systems to collect data that can be used by the data processing system to efficiently assign vehicles to dispensers. The data can indicate characteristics of the vehicles. The characteristics can include a variety of indications of the performance, operation, or status of the vehicle or the battery pack of the vehicle. The data processing system can identify an assignment of a group of vehicles to dispensers that minimizes a total length of time to charge the group of vehicles. The data processing system can transmit the assignments to data processing systems of the vehicles. Through the integration of the data processing systems of the vehicles and the charging station with the data processing system that assigns the vehicles to dispensers, the data processing system that assigns the vehicles to the dispensers can identify vehicle to dispenser assignments that reduces the total length of time to charge a set of vehicles. In view of the reduced total time to charge the vehicles, the overall lifecycle of the dispensers and power cabinets can be extended. Furthermore, the extended duration of time can result in a lower overall power consumption of the dispensers and power cabinets since the dispensers and power cabinets can operate in a charging state for a shorter length of time. In some examples, the overall power consumption may not decrease because the energy needs of the vehicles may be the same regardless of whether the data processing system identifies the vehicle charging assignments.

At least one aspect is directed to a system. The system can include a data processing system. The data processing system can include one or more processors, coupled with memory, to receive data indicating a characteristic of a vehicle. The data processing system can determine, based on at least the characteristic of the vehicle, a length of time to charge the vehicle at a first dispenser and a length of time to charge the vehicle at a second dispenser. The data processing system can assign the vehicle to the first dispenser based on the length of time to charge the vehicle at the first dispenser and the length of time to charge the vehicle at the second dispenser. The data processing system can transmit the assignment of the vehicle to the first dispenser to the vehicle.

At least one aspect is directed to a method. The method can include receiving, by a data processing system including one or more processors, coupled with memory, data indicating a characteristic of a vehicle. The method can include determining, by the data processing system, based on at least the characteristic of the vehicle, a length of time to charge the vehicle at a first dispenser and a length of time to charge the vehicle at a second dispenser. The method can include assigning, by the data processing system, the vehicle to the first dispenser based on the length of time to charge the vehicle at the first dispenser and the length of time to charge the vehicle at the second dispenser. The method can include transmitting, by the data processing system, the assignment of the vehicle to the first dispenser to the vehicle.

At least one aspect is directed to one or more memory devices configured to store instructions thereon that, when executed by one or more processors, cause the one or more processors to receive data indicating a characteristic of a vehicle. The instructions can cause the one or more processors to determine, based on at least the characteristic of the vehicle, a length of time to charge the vehicle at a first dispenser and a length of time to charge the vehicle at a second dispenser. The instructions can cause the one or more processors to assign the vehicle to the first dispenser based on the length of time to charge the vehicle at the first dispenser and the length of time to charge the vehicle at the second dispenser. The instructions can cause the one or more processors to transmit the assignment of the vehicle to the first dispenser to the vehicle.

At least one aspect is directed to a vehicle. The vehicle includes a data processing system including one or more processors, coupled with memory, to receive a characteristic of a battery pack from a battery management system of the battery pack. The data processing system can transmit, via an antenna, the characteristic of the battery pack to a second data processing system. The data processing system can receive, via the antenna, an assignment to charge at a first dispenser of dispensers from the second data processing system, the second data processing system configured to assign, based on the characteristic of the battery pack and a characteristic of a second vehicle, the vehicle to the first dispenser of the dispensers and the second vehicle to the second dispenser of the dispensers that causes a total time to charge the vehicle and the second vehicle to be less than a threshold. The vehicle can charge, via the first dispenser, the battery pack.

At least one aspect is directed to a charging system. The charging system can include a data processing system including one or more processors, coupled with memory, to receive a first status of a first power cabinet from the first power cabinet and a second status of a second power cabinet from the second power cabinet. The data processing system can transmit the first status and the second status to a second data processing system. The data processing system can receive, from the second data processing system, an assignment of a first vehicle to a power dispenser of the first power cabinet and an assignment of a second vehicle to the power dispenser of the second power cabinet, the second data processing system configured to assign, based on the first status and the second status, the first vehicle to the power dispenser of the first power cabinet and the second vehicle to the power dispenser of second power cabinet that causes a total time to charge the first vehicle and the second vehicle to be less than a threshold. The data processing system can configure the first power cabinet to provide power to the first vehicle via the power dispenser of the first power cabinet. The data processing system can configure the second power cabinet to provide power to the second vehicle via the power dispenser of the second power cabinet.

At least one aspect is directed to a system. The system can include a data processing system including one or more processors, coupled with memory, to receive data indicating a characteristic of a first vehicle and a characteristic of a second vehicle. The data processing system can determine, based on at least the characteristic of the first vehicle and the characteristic of the second vehicle, a total time to charge the first vehicle and the second vehicle. The data processing system can assign the first vehicle to a first dispenser of dispensers and the second vehicle to a second dispenser of the dispensers that causes the total time to charge to be less than the threshold. The data processing system transmit the assignment of the first vehicle to the first dispenser to the first vehicle and transmit the assignment of the second vehicle to the second dispenser to the second vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example charging system that assigns vehicles to charge at dispensers of power cabinets.

FIG. 2 depicts an example charging system that assigns a first vehicle to a dispenser of a power cabinet that is charging another vehicle via another dispenser and assigns a second vehicle to a dispenser of a power cabinet that is unoccupied.

FIG. 3 is a block diagram of an example data processing system that assigns vehicles to dispensers of power cabinets.

FIG. 4 is an example vehicle that collects data indicating characteristics of the vehicle and transmits the characteristics to a data processing system.

FIG. 5 depicts an example method of assigning vehicles to dispensers of power cabinets.

FIG. 6 is a block diagram illustrating an architecture for a data processing system that can be employed to implement elements of the systems and methods described and illustrated herein.

### DETAILED DESCRIPTIONS

Following below are more detailed descriptions of various concepts related to, and implementations of, methods, apparatuses, and systems of charging stations for vehicles. The various concepts introduced above and discussed in greater detail below may be implemented in any of numerous ways.

This disclosure is generally directed to charging stations, such as a charging station for electric vehicles. A vehicle, such as an electric vehicle or hybrid vehicle, can include a battery pack that can be charged by a charging station. The charging station can charge at least one vehicle. The charging station can charge multiple vehicles simultaneously. A charging station can be or include at least one power cabinet and at least one dispenser. The charging station can include multiple power cabinets and each power cabinet can include multiple dispensers. Vehicles can be connected to the dispensers to charge via power provided by the power cabinets.

The power cabinets can deliver power to the dispensers to charge vehicles connected to the dispensers. The power cabinets can have a maximum level of power that can be sourced by vehicles via the dispensers. The power cabinet can change or control the amount of power delivered to each dispenser based on the maximum level of power available and the number of vehicles charging at the power cabinet. For example, if a single vehicle is connected to a dispenser of the power cabinet and the other dispensers are unoccupied, the power cabinet can allocate the maximum available amount of power to the dispenser that is charging the single vehicle. This can allow the single vehicle to source a maximum amount of power that the power cabinet can provide. If two vehicles are connected to dispensers of the power cabinet, e.g., a first vehicle connected to charge at a first dispenser of the power cabinet and a second vehicle connected to charge at a second dispenser of the power cabinet, the power cabinet may share the maximum available power across the dispensers. For example, half of the available amount of power can be allocated by the power cabinet to the first dispenser and a second half of the available amount of power can be allocated to the second dispenser.

If the decision to plug into the various dispensers or various power cabinets is left up to a driver, the vehicles can charge in an inefficient manner. For example, in one scenario, two vehicles can be plugged into dispensers of a single power cabinet at a charging station, where the charging station includes two separate power cabinets. This can be less efficient than plugging one vehicle into a dispenser of one power cabinet and the other vehicle into a dispenser of another cabinet. If the two vehicles are plugged into the same power cabinet, they can receive half of the available amount of power of the power cabinet. If the two vehicles are plugged into separate power cabinets, the vehicles can each receive a maximum amount of power from each power cabinet. In another scenario, a driver can determine to charge a vehicle at one power cabinet charging a single vehicle instead of another power cabinet charging two vehicles. If the two vehicles are almost fully charged or are charging at a faster rate than the single vehicle, it may be more efficient to charge the vehicle at the same power cabinet as the two vehicles since the two vehicles will soon complete their charging.

Scenarios such as these can lead to slow charging times for vehicles at a charging station. A slow charging time can result in delays for drivers, passengers, or owners of the vehicles. A slow charging time can result in power cabinets or dispensers operating in a charging state for an extended duration of time. An overall lifecycle of the dispensers or power cabinets can depend on the amount of time the dispensers or power cabinets spend in the charging state. Furthermore, the extended duration of time can result in an increased overall power consumption, for example, the power drawn by the power cabinets or dispensers themselves to operate in a charging state can increase if the power cabinets or dispensers operate for an extended duration of time in the charging state. However, in some examples, the overall power consumption may not decrease. The energy needs of the vehicles may, in some examples, be the same regardless of whether the data processing system identifies the vehicle charging assignments.

To solve these and other technical challenges, the system described herein can include a data processing system that efficiently assigns vehicles to dispensers of at least one charging station to reduce a total time to charge the vehicles. The data processing system can integrate with vehicles and charging systems to collect data that can be used by the data processing system to efficiently assign vehicles to dispensers. The data processing system can collect data from vehicles. The data processing system can collect data from the charging station. The data collected from the vehicles can include or describe characteristics of the vehicles. The characteristics can include a variety of indications of the performance and status of the vehicle or the battery pack of the vehicle. For example, the characteristics can indicate a length of time before the vehicle arrives at the charging station, a charging curve of a battery pack of the vehicle, a state of charge of a battery pack of the vehicle, or a rate at which a vehicle is currently charging. The data received from the charging station can indicate the operational state of the power cabinets or dispensers. For example, the data can indicate which dispensers are unoccupied by a vehicle and which dispensers are being used to charge a vehicle. The data can indicate the amount of power drawn by each vehicle charging at the charging station.

Based on the collected data, the data processing system can identify assignments of the vehicles to different dispensers or power cabinets that reduces the total length of time to charge the vehicles. The data processing system can use the collected data to search through a variety of possible assignments (e.g., assignment scenarios) of vehicles to dispensers and power cabinets to identify one assignment that is associated with a total time to charge the vehicles (e.g., a predicted total time to charge the vehicles) that is less than a threshold. The data processing system can identify an assignment that minimizes a total length of time to charge the vehicles. The data processing system can transmit the assignments to data processing systems of the vehicles. The assignments can be transmitted to mobile devices of drivers of the vehicles. Based on the received assignments, the vehicles can provide notifications to the drivers of the assigned dispenser, assigned power cabinet, or assigned the charging station. Based on the received assignments, the vehicles can provide navigation instructions to drivers of the vehicles to drive the vehicles to the assigned dispensers of the charging station. Based on the received assignments, the vehicles can autonomously or semi-autonomously cause the vehicles to drive to the assigned dispensers.

Through the integration of the data processing systems of the vehicles and charging station with the data processing system that assigns the vehicles to dispensers, the data processing system that assigns the vehicles to the dispensers can identify assignments that consider various factors associated with the vehicles and the charging station to reduce the total time to charge a set of vehicles. In view of the reduced total time to charge the vehicles, the time that occupants, drivers, passengers, or owners of vehicles may need to wait for their vehicles to charge can be greatly reduced. In view of the reduced total time to charge the vehicles, the overall lifecycle of the dispensers and power cabinets can be extended. Furthermore, the extended duration of time can result in a lower overall power consumption of the dispensers and power cabinets since the dispensers and power cabinets operate in charging states for a shorter length of time. In some examples, the overall power consumption may remain the same regardless of whether the data processing system identifies the vehicle charging assignments.

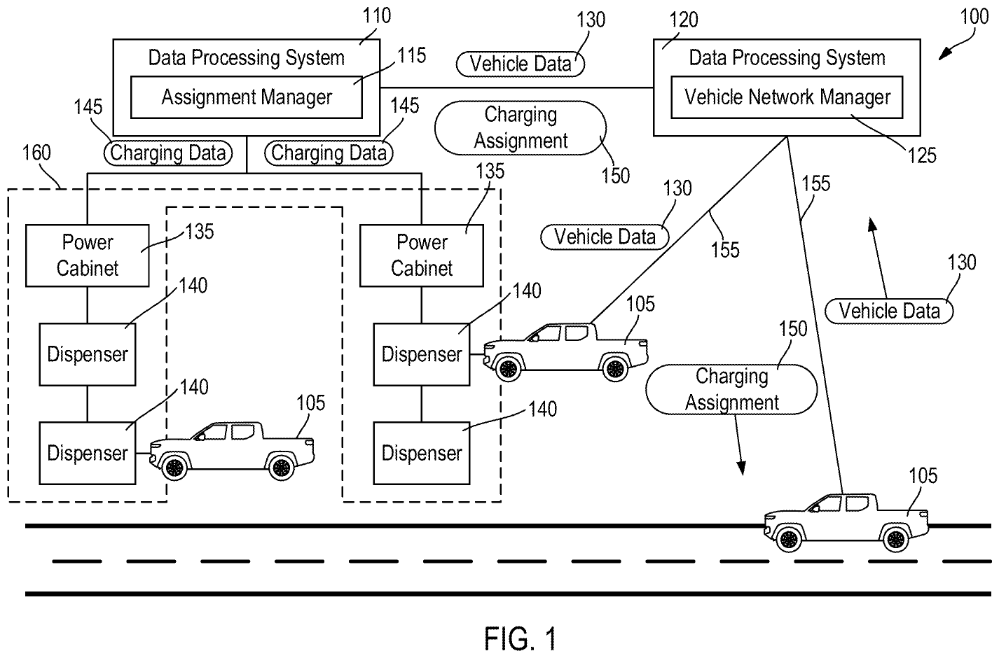

FIG. 1 depicts an example charging system 100 that assigns at least one vehicle 105 to charge at a dispenser 140 of at least one power cabinet 135. The system 100 can include at least one charging station 160. The charging station 160 can include at least one power cabinet 135 and at least one dispenser 140. The charging station 160 can include parking spaces for vehicles 105 to park in front of, next to, or otherwise near the dispensers 140 and charge via the dispensers 140. The power cabinets 135 can be devices, systems, apparatus, or components that receive power from a power source such as an electric grid, a solar panel, a wind turbine, a battery pack, another vehicle 105, or any other power source. The power cabinets 135 can provide power to charge the vehicles 105 through the various dispensers 140 coupled to the power cabinets 135. The power cabinets 135 can include components to implement power conversion, power regulation, power allocation, filtering. The power cabinets 135 can each have a maximum amount of power that the power cabinets 135 can provide to the dispensers 140 connected to the respective power cabinets 135. For example, a first power cabinet 135 may have a first maximum amount of power that the first power cabinet 135 can share between dispensers 140 connected to the first power cabinet 135 while a second power cabinet 135 may have a second maximum amount of power that the second power cabinet 135 can share between dispenser 140 connected to the second power cabinet 135.

The dispensers 140 can be systems, devices, apparatus, or components that receive power from the power cabinet 135 and provide the power to the vehicle 105. The dispensers 140 can include power electronics that implement power conversion, power regulation, power allocation, filtering. The dispensers 140 can include at least one power cable. The power cable can connect to the vehicle 105 via a connecting component. The connection component and the power cable can make one or more electronic connections with the vehicle 105 to deliver power to the vehicle 105, transmit data to the vehicle 105, or receive data from the vehicle 105.

The power cabinet 135 can equally, or substantially equally, share the maximum amount of power between the dispensers 140 connected to the power cabinet 135. For example, if the power cabinet 135 includes two dispensers 140 and both of the dispensers 140 are charging a vehicle 105, the power cabinet 135 can provide half, or substantially half, of the maximum amount of power to each dispenser 140. The power cabinets 135 can provide a portion of the maximum amount of power to vehicles 105 charging at the dispensers 140 inversely proportional to the number of vehicles charging at the dispensers 140. For example, if three vehicles 105 are charging at a power cabinet 135 via the dispensers 140 of the power cabinet 135, the power cabinet 135 can allocate a third of the maximum amount of power to each dispenser 140 charging one of the three vehicles 105. However, if only a single vehicle 105 is connected to the power cabinet 135 through a dispenser 140, the power cabinet 135 can provide the maximum amount of available power to the single vehicle. The power cabinets 135 can share power unequally between the power dispensers 140 connected to each respective power cabinet 135. For example, the power cabinet 135 can sense, detect, or receive an indication how much power can be drawn by each vehicle 105. The power cabinet 135 can unequally share power to the various vehicles 105 charging at the dispensers 140 of the power cabinet 135. The power cabinet 135 can allocate higher amounts of power to vehicles 105 that can source a higher maximum amount of power and allocate lower amounts of power to vehicles 105 that can source a lower maximum amount of power.

The power cabinets 135 can communicate charging data 145 to a data processing system 110 or receive charging data 145 from the data processing system 110. The data processing system 110 can be a component separate from, distributed across, or included within at least one charging station 160, at least one power cabinet 135, at least one dispenser 140, at least one data processing system 120, at least one one vehicle 105. The power cabinet 135 can include one or multiple data processing systems such as the data processing systems described herein. The data processing system 110 can receive vehicle data 130 from a data processing system 120 that receives and collects data from the vehicles 105. The vehicle data 130 can describe characteristics of or associated with the vehicles 105. The data processing system 110 can determine, based on the charging data 145 and the vehicle data 130, charging assignments 150 for assigning various vehicles 105 to various dispensers 140, power cabinets 135, or charging stations 160. The data processing system 110 can include an assignment manager 115. The assignment manager 115 can determine, based on at least one of the charging data 145 and the vehicle data 130, charging assignments 150 for assigning various vehicles 105 to various dispensers 140, power cabinets 135, or charging stations 160. The assignment manager 115 can assign vehicles 105 to charging stations 160, power cabinets 135, or dispensers 140 that are not already assigned or are unassigned. Vehicles 105 that are not assigned can be vehicles that are stationary, powered on, powered off, traveling, traveling to a charging station 160, at a job site, off-road, are planned to be used on a particular trip, or are in any other location or operational state. The assignment manager 115 can further modify, change, or update the assignments of vehicles 105 that are currently assigned to a charging station 160, power cabinet 135, or a dispenser 140 if new data is received or new information is determined by the assignment manager 115 that allows the assignment manager 115 to improve an individual or total time to charge the vehicles 105.

The assignment manager 115 can receive data that indicates a characteristic of at least one vehicle 105. The characteristic can be included in the vehicle data 130. The characteristic can be derived by the assignment manager 115 from the vehicle data 130. The vehicle data 130 can be or include data, data elements, data packets, data structures, data files, or any other type of information. The characteristic can be included in the charging data 145. The charging data 145 can be or include data, data elements, data packets, data structures, data files or any other type of information. The assignment manager 115 can determine, based on at least the characteristic of the vehicle 105, a length of time to charge the vehicle at a first dispenser 140 and a length of time to charge the vehicle at a second dispenser 140. The total lengths of time can be predicted, inferred, or forecasted values. The assignment manager 115 can determine a length of time to charge the vehicle 105 at each dispenser 140 or at each power cabinet 135. The assignment manager 115 can determine a length to charge the vehicle 105 at unoccupied dispensers 140, occupied dispensers 140 (e.g., total length of time to charge the vehicle 105 currently charging at the dispenser 140 and then the unassigned vehicle 105 at the dispenser 140), or a combination of occupied and unoccupied dispensers 140.

The power cabinet 135 can collect charging data 145 indicating whether each dispenser 140 is occupied by a vehicle 105 charging at the dispenser 140 or unoccupied. The charging data 145 can indicate the level of power being consumed by a vehicle 105 at each dispenser 140. For example, the assignment manager 115 can receive a first status indicating that a first dispenser 140 is used by a particular vehicle 105 to charge and a second status of the second dispenser 140 indicating that the second dispenser 140 is available to charge another vehicle 105. The assignment manager 115 can use the statues of the two dispensers 140 to determine the length of time to charge a vehicle 105 that is driving to the charging station 160 at the first dispenser 140 and the length of time to charge the vehicle 105 at the second dispenser 140. The assignment manager 115 can determine to assign the approaching vehicle 105 to the dispenser 140 based on a shortest length of time to charge the approaching vehicle 105, e.g., a dispenser 140 associated with a length of time to charge the approaching vehicle 105 less than a threshold or a length of time associated with a lowest length of time.

The charging data 145 received by the assignment manager 115 can include an indication of a level of power available to be provided by the power cabinets 135 to each of the dispensers 140. For example, the power cabinets 135 can determine, based on an amount of power being sourced by each vehicle 105 charging via the dispensers 140 of each power cabinet 135 or based on a number of dispensers 140 occupied by charging vehicles 105, how much power would be available to an unassigned vehicle 105 at each dispenser 140. Based on the level of power available at each dispenser 140, the assignment manager 115 can determine a length of time to charge the approaching vehicle 105 at each dispenser 140. The assignment manager 115 can generate a charging assignment 150 to assign the unassigned vehicle 105 to the dispenser that will provide the shortest length of time to charge the unassigned vehicle 105, or a length of time to charge that unassigned vehicle 105 that is less than a threshold.

The assignment manager 115 can determine or predict a length of time to charge at least one unassigned vehicle 105 at least one dispenser 140. The assignment manager 115 can predict lengths of time to charge each unassigned vehicle 105 at the dispensers 140 for various scenarios. Each scenario can be one particular assignment of vehicles 105 to dispensers 140 or power cabinets 135. The assignment manager 115 can identify all possible assignments or a set of possible assignments. The assignment manager 115 can determine, for each assignment scenario, a total length of time to charge all of the vehicles 105 or a set of the vehicles 105. The assignment manager 115 can identify a particular scenario, e.g., a set of assignments of vehicles 105 to various dispensers 140, that minimizes a total length of time to charge the vehicles 105, optimizes a total length of time to charge the vehicles 105, or identifies a total length of time to charge the vehicles 105 that is less than a threshold. The assignment manager 115 can generate a charging assignment 150 based on the identified set of assignments of vehicles 105. The assignment manager 115 can apply various computing processes that search through a set of possible assignments or all possible assignments. For example, the assignment manager 115 to perform a least squares computer process, a random forest, an optimization computer process that identifies an optimal assignment, a maximization computer process that identifies an assignment that maximizes a parameter, a minimization computer process that identifies an assignment that minimizes a parameter (e.g., minimizes a length of time to charge a vehicle 105 or minimizes a total length of time to charge a set of vehicles 105).

For example, the assignment manager 115 can receive characteristics of at least one vehicle 105, the characteristic of the vehicle 105 including at least one of a state of charge of a battery pack of the vehicle 105 or a charging curve of the battery pack of the vehicle 105. The assignment manager 115 can determine the length of time to charge the vehicle 105 at one or multiple dispensers 140 for one or multiple power cabinets 135. For example, the assignment manager 115 can determine a length of time to charge the vehicle 105 at a first dispenser 140 and a length of time to charge the vehicle 105 at a second dispenser 140 based on at least one of the state of charge of the battery pack of the vehicle 105, the charging curve of the battery pack of the vehicle 105, or an available amount of power that a power cabinet 135 or dispenser 140 can provide to the vehicle 105.

The charging assignment 150 can be an overall assignment including an identification of the assignment of every vehicle 105 to particular charging stations 160, dispensers 140, or power cabinets 135. The charging assignment 150 can be vehicle specific, e.g., each charging assignment 150 can indicate the charging station 160, dispenser 140, or power cabinet 135 assigned to one particular vehicle 105. For example, the assignment manager 115 can determine a charging assignment for an approaching vehicle 105 and cause the charging assignment 150 to be transmitted to the approaching vehicle 105. The charging assignment 150 can indicate a coordinate, address, dispenser number, cabinet number, or other piece of data indicating the charging station 160, power cabinet 135, or dispenser 140 that the approaching vehicle 105 is assigned to. The data processing system 110 can transmit the charging assignment 150 to the vehicle 105 by communicating the charging assignment 150 to the data processing system 120. The data processing system 110 can transmit the charging assignment 150 to the approaching vehicle 105.

The data processing system 120 can include a vehicle network manager 125. The vehicle network manager 125 can establish at least one communication connection 155 with at least one vehicle 105. The vehicle network manager 125 can establish communication connections 155 for communicating with the vehicles 105 via wireless communication channels, wired communication channels, or a combination thereof. For example, the vehicle network manager 125 can communicate with the vehicles 105 via 4G networks, 5G networks, 6G networks, Wi-Fi networks, core networks, Local Area Networks (LANs), Wide Area Networks (WANs), Metropolitan Area Networks (MANs), Wi-Fi networks, Bluetooth connections, or any combination thereof. At least one vehicle 105 can communicate with the vehicle network manager 125 or the data processing system 120 via the communication connections 155. The vehicle network manager 125 can communicate with vehicles 105 that are charging, not charging, assigned to a charging station 160, power cabinet 135, or dispenser 140, not assigned to a charging station 160, power cabinet 135, or dispenser 140.

The vehicle network manager 125 can receive vehicle data 130 from at least one vehicle 105. The vehicles 105 can transmit the vehicle data 130 to the vehicle network manager 125 via the communication connection 155. The vehicle data 130 can describe various characteristics of the vehicle 105 that transmitted the vehicle data 130 to the vehicle network manager 125. The vehicle data 130 can describe at least one characteristic of second vehicle 105 that transmits the vehicle data 130 to a first vehicle 105 which in turn communicates the vehicle data 130 to the vehicle network manager 125. The characteristics can be or include a state of charge of a battery pack of the vehicle 105, a charging curve of the battery pack of the vehicle 105, a state of health of the battery pack of the vehicle 105, a time of day or date that the vehicle 105 will arrive at the charging station 160, a temperature of the battery pack of the vehicle 105, a navigation route of the vehicle 105, a level of traffic on the navigation route of the vehicle 105 to the charging station 160. The vehicle network manager 125 can collect vehicle data 130 from one or multiple different vehicles 105. The vehicle network manager 125 can store a repository of vehicle characteristics for at least one vehicle 105. The vehicle network manager 125 can communication, transmit, convey, or publish the vehicle data 130 to the assignment manager 115.

The vehicle network manager 125 can receive the charging assignment 150 from the assignment manager 115. The vehicle network manager 125 can communicate, convey, publish, or transmit the charging assignment 150 to at least one vehicle 105. The vehicle network manager 125 can transmit the charging assignment 150 of each specific vehicle 105 to each particular vehicle 105. The vehicle network manager 125 can transmit all of the charging assignments 150 of multiple vehicles 105 to at least one vehicle 105. The vehicle network manager 125 can transmit charging assignments 150 to vehicles 105 that are not assigned. The vehicle network manager 125 can transmit the charging assignment 150 to a data processing system of the vehicle 105. The vehicle network manager 125 can transmit the charging assignment 150 to a user device of an occupant (e.g., a driver or passenger) or another individual associated with the vehicle 105, e.g., an owner of the vehicle 105, a foreman for a job, a repair person, etc. The user device can be or include a smartphone, a tablet, a laptop computer, a desktop, a smart watch, or any other portable or stationary computing system or device.

The charging assignment 150 can cause the vehicle 105 to autonomously or semi-autonomously drive the vehicle 105 to the assigned dispenser 140. The charging assignment 150 can be or include configuration data that configures a data processing system of the vehicle 105 to autonomously or semi-autonomously drive to the assigned dispenser 140. The charging assignment 150 can be or include configuration data that configures a navigation system of the vehicle 105 to display driving directions to drive to the dispenser 140 that the vehicle 105 is assigned to.

The assignment manager 115 can transmit the charging assignment 150 to the power cabinets 135. The assignment manager 115 can configure the power cabinets 135 to charge specific vehicles 105 by allocating a particular amount of power for the vehicles 105. The assignment manager 115 can be configured by the assignment manager 115 to reserve a dispenser 140 at a particular time or date for a particular vehicle 105. The dispenser or the power cabinet 135 can communicate with a particular vehicle 105 to identify and authorize the vehicle 105 and provide power via the dispenser 140 to the particular vehicle 105 responsive to the vehicle 105 being identified, authorized, and scheduled to receive power at the particular dispenser 140. The power cabinet 135 or the dispenser 140 can include a processing system that stores a schedule of vehicles 105 assigned to the dispensers 140 and compare the identify of a vehicle 105 attempting to charge at the dispenser 140 to the scheduled vehicle 105 to verify that the vehicle 105 attempting to charge is the scheduled vehicle 105. The processing system can compare a current date or time to verify that the vehicle 105 is attempting to charge at the appropriate time.

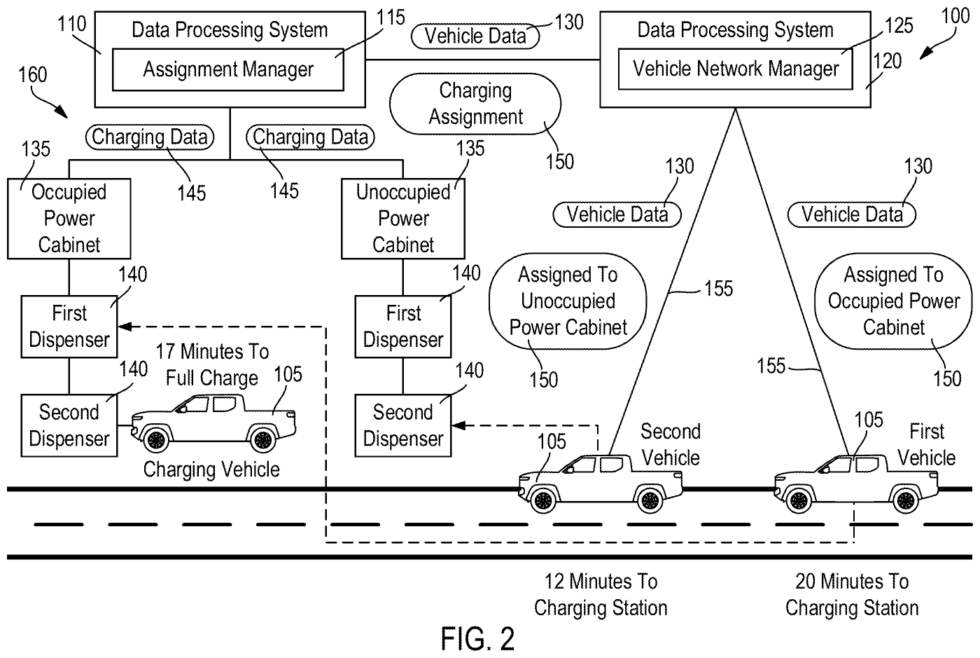

FIG. 2 depicts an example charging system 100 that assigns a first vehicle 105 to a dispenser 140 of a power cabinet 135 that is charging another vehicle 105 via another dispenser 140 and assigns a second vehicle 105 to a dispenser 140 of a power cabinet 135 that is unoccupied. The vehicle network manager 125 can receive vehicle data 130 from the first vehicle 105 and the second vehicle 105. The first vehicle 105 can transmit vehicle data 130 to the vehicle network manager 125 that indicates characteristics of the first vehicle 105. The vehicle network manager 125 can receive the vehicle data 130 from the first vehicle 105. The second vehicle 105 can transmit vehicle data 130 to the vehicle network manager 125 that indicates characteristics of the second vehicle 105. The vehicle network manager 125 can receive the vehicle data 130 from the second vehicle 105. The vehicle network manager 125 can communicate the vehicle data 130 collected from the first vehicle 105 and the second vehicle 105 to the assignment manager 115.

The vehicle data 130 can indicate a length of time that it will take the first vehicle 105 and the second vehicle 105 to reach the charging station 160. The vehicle data 130 can indicate a current location of the first vehicle 105 or the second vehicle 105 or a length of time it will take the first vehicle 105 or the second vehicle 105 to reach the charging station 160. The vehicle network manager 125 can communicate the vehicle data 130 to the assignment manager 115. The assignment manager 115 can use the characteristics of the first vehicle 105 and the second vehicle 105 indicated by the vehicle data 130 to determine assignments at the power cabinets 135 or dispensers 140. The assignment manager 115 can determine assignments of the first vehicle 105 and the second vehicle 105 that causes a total time to charge all of the vehicles 105 (e.g., the first vehicle 105, the second vehicle 105, and any vehicles currently charging at the charging station 160) to be less than or equal to a threshold. The threshold could be a minima, e.g., the assignment manager 115 can determine an assignment that identifies a shortest or minimal total time to charge the vehicles 105.

The assignment manager 115 can receive vehicle data 130 that indicates or includes a time to arrival of at least one vehicle 105 at the charging station 160. For example, the assignment manager 115 can receive a first time of arrival of the first vehicle 105 and a second time of arrival of the second vehicle 105. If the vehicle data 130 does not include the time of arrival and instead includes a location of the vehicle 105, speed of the vehicle 105, or direction that the vehicle 105 is traveling, the assignment manager 115 can use the vehicle data 130 to compute the estimated time to arrival of the vehicle 105 at the charging station 160. The assignment manager 115 can receive or determine the time to arrival of the first vehicle 105 at the charging station 160 and the time to arrival of the second vehicle 105 at the charging station 160. The assignment manager 115 can determine, based on the lengths of time of arrival of at least one of the first vehicle 105 and the second vehicle 105, the length of time to charge the first vehicle 105 at one or multiple dispensers 140, e.g., a first dispenser 140 of the occupied power cabinet 135, a second dispenser 140 of the occupied power cabinet 135, a first dispenser 140 of an unoccupied power cabinet 135, a second dispenser 140 of an unoccupied power cabinet 135. The assignment manager 115 can determine, based on the lengths of time of arrival of at least one of the first vehicle 105 and the second vehicle 105, the length of time to charge the second vehicle 105 at one or multiple dispensers 140, e.g., a first dispenser 140 of the occupied power cabinet 135, a second dispenser 140 of the occupied power cabinet 135, a first dispenser 140 of an unoccupied power cabinet 135, a second dispenser 140 of an unoccupied power cabinet 135. The assignment manager 115 can determine, predict, or forecast a total length of time to charge the first vehicle 105 and the second vehicle 105 based on the lengths of time to charge the first vehicle 105 and the second vehicle 105 at the various dispensers 140 for various scenarios, e.g., assignments of the first vehicle 105 and the second vehicle 105 to various dispensers 140.

The assignment manager 115 can determine the lengths of time to charge the first vehicle 105 and the second vehicle 105 at the dispensers 140 based on the charging data 145 received from the power cabinets 135. The charging data 145 can indicate that one power cabinet 135 is occupied. The charging data 145 can indicate how many vehicles are charging at the occupied power cabinet 135. The charging data 145 can indicate how much power each charging vehicle 105 is consuming. The charging data 145 (or vehicle data 130) for a vehicle 105 that is currently charging can indicate a total length to full charge or to a certain charge level. The assignment manager 115 can determine the total length to charge the vehicle 105 that is currently charging from the charging data 145 or the vehicle data 130. The assignment manager 115 can determine a total length of time to charge the first vehicle 105 and the second vehicle 105 based on the lengths of time to charge the first vehicle 105 and the second vehicle 105 at the various dispensers 140 and the charging data 145 indicating a length of time to charge a vehicle 105 currently charging at one of the dispensers 140.

The assignment manager 115 can receive an indication that a vehicle 105 is currently charging at the dispenser 140 of the occupied power cabinet 135. The occupied power cabinet 135 can be configured to share an available amount of power between a first dispenser 140 connected to the occupied power cabinet 135 and a second dispenser 140 that is connected to the occupied power cabinet 135 that is currently charging the vehicle 105. The charging data 145 or the vehicle data 130 can indicate a length of time that the charging vehicle 105 will take to charge, e.g., seventeen minutes. The assignment manager 115 can receive vehicle data 130 that indicates a length of time that it will take the first vehicle 105 to reach the charging station 160. The length of time can be twenty minutes. The assignment manager 115 can receive vehicle data 130 that indicates a length of time that it will take the second vehicle 105 to reach the charging station 160. The length of time can be twelve minutes. The length of time for the first vehicle 105 to reach the charging station 160 can be greater than the length of time for the second vehicle 105 to reach the charging station 160.

The assignment manager 115 can determine an assignment of the first vehicle 105 and the second vehicle 105 that considers the time to arrival of the first vehicle 105, the second vehicle 105, the length of time to charge the charging vehicle 105, the length of time to charge the first vehicle 105, and the length of time to charge the second vehicle 105. The assignment manager 115 can determine an assignment that minimizes or identifies a total length of time to charge at least one of the first vehicle 105, the second vehicle 105, and the charging vehicle 105 that is less than a threshold or value. Because the second vehicle 105 will reach the charging station 160 before the first vehicle 105, the assignment manager 115 can assign the second vehicle 105 to a dispenser 140 of an unoccupied power cabinet 135, a power cabinet 135 where no other vehicles are charging. The assignment manager 115 can assign the first vehicle 105 to the first dispenser 140 of the occupied power cabinet 135 where the vehicle 105 is charging at the second dispenser 140 of the occupied power cabinet 135. Because it will take twenty minutes for the first vehicle 105 to reach the charging station 160, there will only be three minutes where the first vehicle 105 and the charging vehicle 105 will both be charging at the occupied charging station 160 simultaneously and the maximum power of the occupied power cabinet 135 is shared between the first dispenser 140 and the second dispenser 140 of the occupied power cabinet 135.

The assignment manager 115 can determine that after the three minutes where the first vehicle 105 and the charging vehicle 105 simultaneously charge at the occupied power cabinet 135 and share the maximum available power of the power cabinet 135, the first vehicle 105 will be able to receive the full amount of power of the power cabinet 135. The assignment manager 115 can determine to assign the first vehicle 105 to charge at the occupied power cabinet 135 because the first vehicle 105 will reach the charging station 160 later than the second vehicle 105. If the second vehicle 105 were to be assigned to the first dispenser 140 of the occupied power cabinet 135, the second vehicle 105 and the charging vehicle 105 would be charging and sharing power of the occupied power cabinet 135 for seven minutes. Therefore, the assignment manager 115 can determine the assignments 150 to be the first vehicle 105 assigned to the first dispenser 140 of the occupied power cabinet 135 and the second vehicle 105 to one of the first dispenser 140 or the second dispenser 140 of the unoccupied power cabinet 135.

The assignment manager 115 can transmit the charging assignments 150 to the vehicle network manager 125. The vehicle network manager 125 can distribute the assignments of the first vehicle 105 and the second vehicle 105. For example, the vehicle network manager 125 can transmit the assignment 150 of the first vehicle 105 to a dispenser 140 of the occupied power cabinet 135 (e.g., to the first dispenser 140 of the occupied power cabinet 135) to the first vehicle 105. The vehicle network manager 125 can transmit the assignment 150 of the second vehicle 105 to a dispenser 140 of the unoccupied power cabinet 135 to the second vehicle 105.

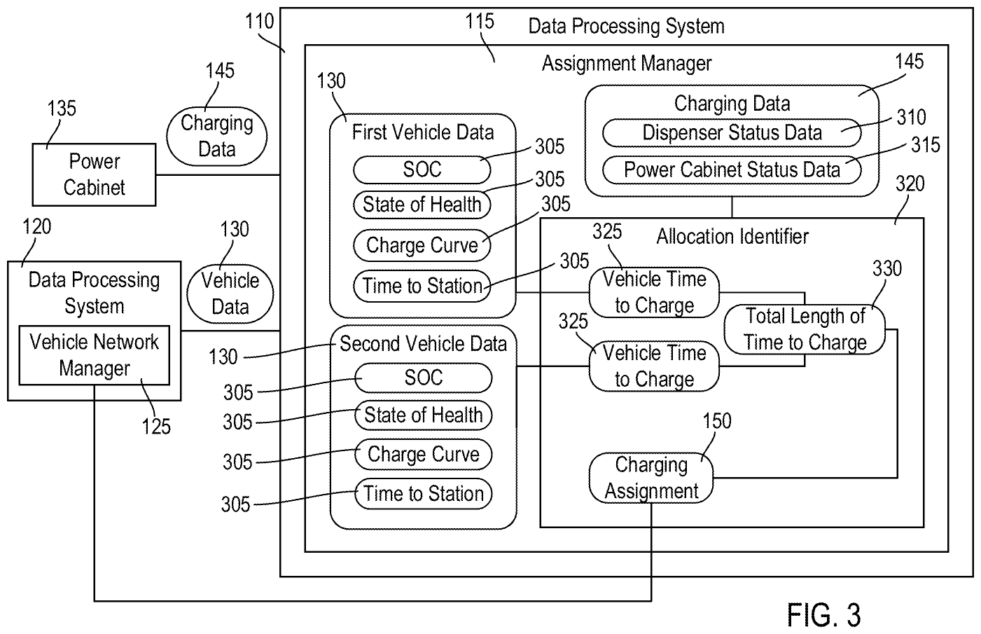

FIG. 3 is a block diagram of an example data processing system 110 that assigns vehicles 105 to dispensers 140 of power cabinets 135. The data processing system 110 includes at least one assignment manager 115. The assignment manager 115 can receive the charging data 145 from at least one power cabinet 135. The charging data 145 can be stored by the assignment manager 115. The charging data 145 can include dispenser status data 310. The dispenser status data 310 can indicate whether each dispenser 140 for a particular power cabinet 135 is occupied by a vehicle 105. The charging data 145 can include power cabinet status data 315. The power cabinet status data 315 can indicate whether each power cabinet 135 has a vehicle 105 charging at it or not. The power cabinet status data 315 can indicate a level of power allocated to each vehicle 105 charging at the power cabinet 135.

The assignment manager 115 can receive vehicle data 130. The assignment manager 115 can receive vehicle data 130 from individual vehicles 105 through the vehicle network manager 125 of the data processing system 120. For example, for a first vehicle 105, the assignment manager 115 can receive and store first vehicle data 130. For a second vehicle 105, the assignment manager 115 can receive and store second vehicle data 130. The vehicle data 130 can include or indicate various characteristics of the vehicles 105. For example, the characteristics can be included within the vehicle data 130 or the vehicle characteristics 305 can be determined or calculated by the assignment manager 115 from the vehicle data 130 or the charging data 145. The characteristics 305 can include a state of charge of a battery pack of a vehicle 105, battery modules, or battery cells of the vehicles 105. The characteristics 305 can include a state of health of a battery pack, battery modules, or battery cells of the vehicle 105. The health can indicate an ability or any constraints on the rate at which the vehicle 105 can charge. The characteristics 305 can include a charging curve for a battery pack, battery module, or battery cell of the vehicle 105. The charging curve can indicate a variable rate over time at which the vehicle 105 charges. The characteristics 305 can indicate the voltage or current curve for a battery pack, a battery module, or a battery cell of the vehicle 105.

The data processing system 110 can determine, based on the time to station 305, a point in the charging curve associated with an arrival of the vehicle 105 at the station 160. The data processing system 110 can account for when vehicles arrive at the charging station 160 at different times and at differing points in their charging curves and generate the charging assignment 150 based on the different arrival times and differing charging curve points. For example, the data processing system 110 can determine that a vehicle 110 arriving at a present or current time should share power with a vehicle already charging if the data processing system 110 identifies that additional vehicles 105 are arriving soon (e.g., within a period of time such as 5 minutes, 20 minutes, a half hour, an hour). The data processing system 110 can optimize charging time for one customer or optimize charging times collectively for multiple customers.

The assignment manager 115 can include at least one allocation identifier 320. The allocation identifier 320 can determine, predict, or forecast a vehicle time to charge 325 for each vehicle 105 for each dispenser 140, each power cabinet 135, or each charging station 160 or combinations dispensers 140, power cabinets 135, or charging stations 160. For example, the allocation identifier 320 can identify multiple different possible scenarios to assign a vehicle 105 approaching the charging station 160, a vehicle 105 that is not charging at the charging station 160, or a vehicle 105 not assigned to a dispenser 140 or power cabinet 135. The assignment identifier 320 can determine a length of time to charge each vehicle for each possible assignment scenario (or for a set of assignment scenarios). The length of time can be the vehicle time to charge 325, a length of time that it will take a particular vehicle to charge at a particular dispenser 140 (e.g., a first dispenser 140, a second dispenser 140) or power cabinet 135 including any other intervening times, e.g., waiting for a dispenser 140 to become free of a vehicle 105 currently charging at the dispenser 140.

The allocation identifier 320 can determine, for each scenario of assignments of the vehicles 105 (e.g., a first vehicle 105 and a second vehicle 105) to the dispensers 140 and the power cabinets 135, a total length of time to charge 330 based on the vehicle times to charge 325 (e.g., a first vehicle time to charge 325 for a first vehicle 105 and a second vehicle time to charge 325 for a second vehicle 105) for each vehicle 105 for the particular scenario. The allocation identifier 320 can determine a total length of time to charge 330 based on each possible assignment scenario or for a set of assignment scenarios. The allocation identifier 320 can execute a computer process to identify an assignment scenario with a total length of time to charge 330 that is less than a particular level (e.g., is a minimum value). For example, the allocation identifier 320 can perform a least squares computer process, a random forest, an optimization computer process that identifies an optimal assignment, a maximization computer process that identifies an assignment that maximizes a parameter (e.g., maximizes battery life, maximizes rate of charge, etc.), a minimization computer process that identifies an assignment that minimizes a parameter such as the total length of time to charge 330.

The allocation identifier 320 can select one total length of time to charge 330 that is less than a threshold or is the shortest length of time. The allocation identifier 320 can generate the charging assignment 150 to be the assignment of vehicles 105 for the scenario associated with the total length of time to charge 330 that is selected by the allocation identifier 320. The scenario can indicate that a shortest total length of time to charge 330 can be achieved if a first vehicle 105 is assigned to a first dispenser 140 of a power cabinet 135 and a second vehicle 105 is assigned to a second dispenser 140 of a power cabinet 135. The allocation identifier 320 can communicate the charging assignment 150 to the vehicle network manager 125 for distribution to the vehicles 105.

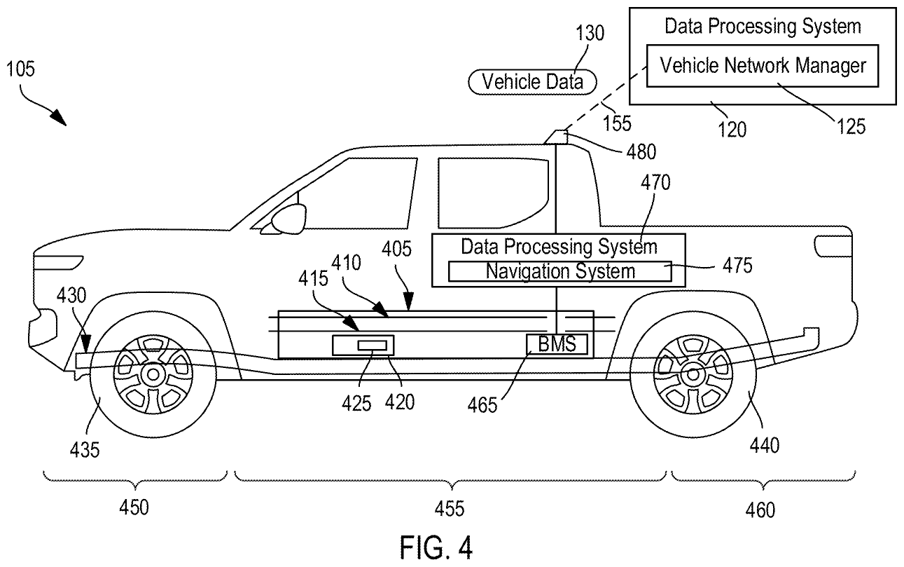

FIG. 4 is an example vehicle 105 that collects data indicating characteristics of a vehicle and transmits the characteristics to a data processing system 120. The electric vehicle 105 can be installed with at least one battery pack 405. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 405 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 405, battery modules 420, or battery cells 425 to power the electric vehicles. The electric vehicle 105 can include a chassis 430 (e.g., a frame, internal frame, or support structure). The chassis 430 can support various components of the electric vehicle 105. The chassis 430 can span a front portion 450 (e.g., a hood or bonnet portion), a body portion 455, and a rear portion 460 (e.g., a trunk, payload, or boot portion) of the electric vehicle 105. The battery pack 405 can be installed or placed within the electric vehicle 105. For example, the battery pack 405 can be installed on the chassis 430 of the electric vehicle 105 within one or more of the front portion 450, the body portion 455, or the rear portion 460. The battery pack 405 can include or connect with at least one busbar, e.g., a current collector element. For example, the first busbar 410 and the second busbar 415 can include electrically conductive material to connect or otherwise electrically couple the battery modules 420 or the battery cells 425 with other electrical components of the electric vehicle 105 to provide electrical power to various systems or components of the electric vehicle 105.

The vehicle 105 can include two front wheels 435 and two rear wheels 440. The vehicle 105 can include one or multiple motors. The motors can drive an axel connected to the two front wheels 435 or an axel connected to the two rear wheels 440. A single motor can drive an axel of the two front wheels 435. A single motor can drive an axel of the two rear wheels 440. Each wheel of the wheels 435 and 440 can be driven by an individual motor. For example, each of the four wheels 435 and 440 can be driven by one of four motors. The battery pack 405 can discharge stored energy to power the motors of the front wheels 435 and the rear wheels 440. The battery pack 405 can discharge stored energy to generate power that the motors receive. Operating the motors of the wheels 435 and 440 can cause the vehicle 105 to drive forward, reverse, or turn.

The vehicle 105 can include a data processing system 470. The data processing system can be electrically coupled with various electrical systems of the vehicle 105 and can receive data from the electrical systems of the vehicle 105. For example, the data processing system 470 can interface with a battery management system (BMS) 465 which may be a component of a high voltage distribution box (HVDB). The data processing system 470 can be electrically connected to motor controllers that control the motors of the front wheels 435 and the rear wheels 440. The data processing system 470 can control the movement of the vehicle 105 to autonomously or semi-autonomously drive the vehicle 105.

The data processing system 470 can include a navigation system 475. The navigation system 475 can collect at least one data packet, data element, or piece of information from the BMS 465 of the battery pack 405 of the vehicle 105. The navigation system 475 can track a position (e.g., coordinate position) of the vehicle 105 via at least one global positioning system (GPS) of the vehicle 105. The navigation system 475 can provide navigation instructions, based on the position of the vehicle 105, to navigate the vehicle 105 from a first location (e.g., an origin location) to a second location (e.g., a destination location). The second location can be the charging station 160. The navigation system 475 can identify a route on one or more roads from the first location to the second location. The navigation system 475 can collect data from various sensors or other computer systems or software modules of the vehicle 105 to identify a speed of the vehicle, a heading of the vehicle 105 (e.g., a direction of travel of the vehicle 105), etc. The navigation system 475 can determine, based on the speed of the vehicle, the navigation route to the charging station 160, traffic levels on the navigation route, speed limits on roads of the navigation route, etc. the length of time it will take the vehicle 105 to reach the charging station 160. The navigation system 475 can generate a vehicle data 130 to include the data that the navigation system 475 collects or generates or the time to station that the navigation system 475 generates.

The data processing system 470 can cause the vehicle data 130 generated or collected by the navigation system 475 or the data processing system 470 to the data processing system 120 (or the vehicle network manager 125) via the communication connection 155. The vehicle 105 can include at least one antenna 480. The data processing system 470 can cause at least one antenna 480 of the vehicle 105 to transmit the vehicle data 130 to the data processing system 120. The antenna 480 can be a cellular antenna for communicating via a cellular network such as a 3G network, a 4G network, a 5G network, a 6G network.

The data processing system 470 or the antenna 480 can implement wireless communication with other systems or devices, e.g., with the data processing system 120 or other vehicles 105. The wireless communication can include wirelessly transmitting data to another system or device. The communication can include wirelessly receiving data from the other system or device. The data processing system 470 or the antenna 480 can include one or multiple circuits that implement radio communication with a radio access network (RAN) or with a second vehicle 105. The data processing system 470 or the antenna 480 can include antennas, receivers, transmitters, transceivers, filters, amplifiers, digital signal processing units, modulators, front end modules, or other hardware to implement signal processing for radio communication. The data processing system 470 or the antenna 480 can implement cellular communication with a cellular network (e.g., a RAN). The data processing system 470 or the antenna 480 can implement Wi-Fi communication with a Wi-Fi network. The data processing system 470 or the antenna 480 can implement Bluetooth communication with Bluetooth devices. The data processing system 470 or the antenna 480 can implement communication over a local area network (LAN), a wide area network (WAN), or a metropolitan area network (MAN). The data processing system 470 or the antenna 480 can connect the first electric vehicle 105 to the Internet via communication with one or more networks. The data processing system 470 or the antenna 480 can implement device-to-device or ad-hoc communication with the second vehicle 105. The data processing system 470 or the antenna 480 can implement an inter-vehicle communication protocol to communicate directly with the second vehicle 105 without communicating over with a cellular tower or RAN. The inter-vehicle communication protocol can be a peer-to-peer communication protocol. The inter-vehicle communication protocol can include Sidelink or another communication protocol that performs direct vehicle to vehicle communication.

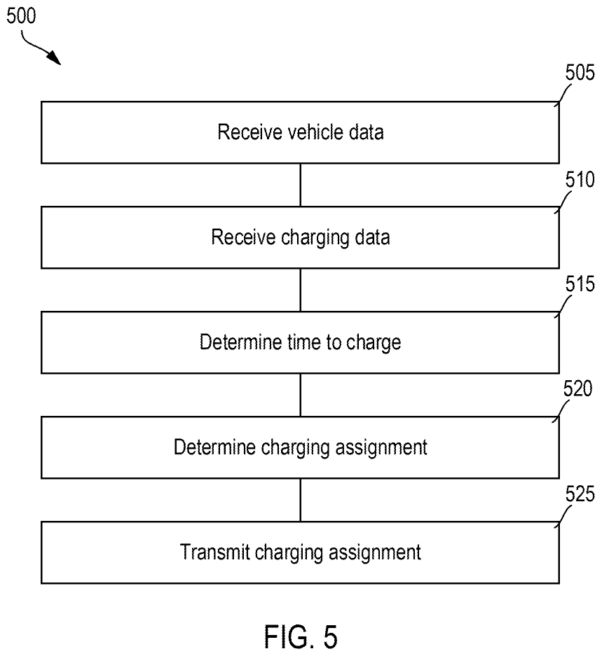

FIG. 5 depicts an example method 500 of assigning vehicles 105 to dispensers 140 of power cabinets 135. At least one ACT of the method 500 can be performed by the assignment manager 115 of the data processing system 110. At least one ACT of the method 500 can be performed by the vehicle network manager 125 of the data processing system 120. At least one ACT of the method 500 can be performed by the vehicles 105. The method 500 can include an ACT 505 of receiving vehicle data. The method 500 can include an ACT 510 of receiving charging data. The method 500 can include an ACT 515 of determining a time to charge. The method 500 can include an ACT 520 of determining a charging assignment. The method 500 can include an ACT 525 of transmitting a charging assignment.

The method 500 can include an ACT 505 of receiving, by the data processing system 110, vehicle data. The assignment manager 115 of the data processing system 110 can receive vehicle data 130 directly from the vehicles 105 or from the vehicle network manager 125 of the data processing system 120. The vehicle data 130 can be received for vehicles 105 that are unassigned to dispensers 140 or power cabinets 135. The vehicle data 130 can be received for vehicles 105 that are currently charging at dispensers 140 or power cabinets 135. The vehicle data 130 can indicate or include characteristics of the vehicles 105. The characteristics can be or include a state of charge of a battery pack 405 of the vehicle 105, a charging curve of the battery pack 405 of the vehicle 105, a current rate of charge of a currently charging vehicle 105, a length of time until full charge (or SOC above a particular threshold is reached), a state of health of the battery pack 405 of the vehicle 105, a time of day that the vehicle 105 will arrive at the charging station 160, a temperature of the battery pack 405 of the vehicle 105, a navigation route of the vehicle 105, and a level of traffic on the navigation route of the vehicle 105 to the charging station 160.

The assignment manager 115 can derive characteristics of the vehicles 105 from the vehicle data 130. For example, if the vehicle data 130 indicates a location of the vehicle 105, the assignment manager 115 can determine a length of time that it will take the vehicle 105 to reach the charging station 160 based on a distance between the vehicle 130 and the charging station 160. For example, if the vehicle data 130 indicates a charging curve of the vehicle 105 and an SOC of a battery pack 405 of the vehicle 105, the vehicle data 130 can determine a length of time until the vehicle 105 is fully charged (or charged to a particular level).

The method 500 can include an ACT 510 of receiving, by the data processing system 110, charging data 145. The charging data 145 can be or include data collected by the power cabinets 135 or the dispensers 140. The charging data 145 can indicate a status of at least one dispenser 140 or at least one power cabinet 135. The status can indicate whether a dispenser 140 is occupied by a vehicle 105 currently charging at the dispenser 140 or unoccupied and no vehicle 105 is charging at the dispenser 140. The status can indicate whether a power cabinet 135 is providing power to a vehicle 105 to charge the vehicle 105. The status can indicate the number of vehicles 105 charging at the dispensers 140 of a particular power cabinet 135. The status can indicate a power level allocated by a particular power cabinet 135 to each dispenser 140 of the particular power cabinet 135. The status can indicate a level of power sourced by vehicles 105 charging at dispensers 140 of a particular power cabinet 135.

The method 500 can include an ACT 515 of determining, by the data processing system 110, a time to charge. The assignment manager 115 can determine the time to charge based on at least one of the vehicle data 130 and the charging data 145. The time to charge can be a vehicle time to charge 325 for a specific vehicle 105. The assignment manager 115 can determine a vehicle time to charge 325 for a specific vehicle 105 for a variety of different potential assignments to dispensers 140 or power cabinets 135. The assignment manager 115 can determine, based at least in part on the variety of vehicle times to charge 325, an assignment of the particular vehicle 105 to one dispenser 140 or power cabinet 135 that results in a vehicle time to charge 325 that is less than a threshold or is an shortest vehicle time to charge.

The assignment manager 115 can determine a total length of time to charge 330 based on the vehicle time to charges 325 for the particular vehicle and a variety of other vehicle time to charges 325 for another vehicle 105. The other vehicle 105 can be a vehicle currently assigned to charge at a particular dispenser 140 or power cabinet 135. The total length of time to charge 330 can take into account the variety of different potential assignments of the first vehicle 105 to various dispensers 140 or power cabinets 135. These assignments can affect the currently charging vehicle 105. For example, if the first vehicle 105 is assigned to charge at the same power cabinet 135 as the currently charging vehicle 105, this may slow down the rate at which the currently charging vehicle 105 is charging because the power cabinet 135 may start to share power between the two vehicles 105. The assignment manager 115 can determine multiple total lengths of time to charge 330 for multiple different assigned vehicles 105 that are currently charging or will be charging at a particular dispenser 140 or power cabinet 135. The assignment manager 115 can determine multiple total lengths of time to charge 330 for multiple different unassigned vehicles 105 that are not currently charging or are not yet assigned to charge a dispenser 140 or power cabinet 135. The various vehicle time to charge values 325 can take into account a variety of different possible charging assignment scenarios. When combined, each particular charging assignment scenario can be associated with a particular total length of time to charge 330.

The method 500 can include an ACT 520 of determining, by the data processing system 110, a charging assignment 150. The assignment manager 115 can identify a charging assignment 150 by identifying a particular assignment scenario of vehicles 105 to various dispensers 140 or power cabinets 135 though performing a least squares computer process, a random forest, an optimization computer process that identifies an optimal assignment, a maximization computer process that identifies an assignment that maximizes a parameter, a minimization computer process that identifies an assignment that minimizes the total length of time to charge 330. The identified assignment scenario can indicate assignments for one or multiple vehicles 105 to specific power cabinets 135 or specific dispensers 140 for specific power cabinets 135.

The method 500 can include an ACT 525 of transmitting, by the data processing system 110, a charging assignment. The assignment manager 115 can transmit the charging assignment 150 to at least one vehicle 105. The assignment manager 115 can transmit a first charging assignment 150 for a first vehicle 105 to the first vehicle 105. The assignment manager 115 can transmit a second charging assignment 150 for a second vehicle 105 to the second vehicle 105. The assignment manager 115 can transmit the charging assignments 150 directly to the vehicles 105. The assignment manager 115 can transmit the charging assignments 150 to the vehicle network manager 125 for the vehicle network manager 125 to distribute or transmit the charging assignments 150 to the vehicles 105.

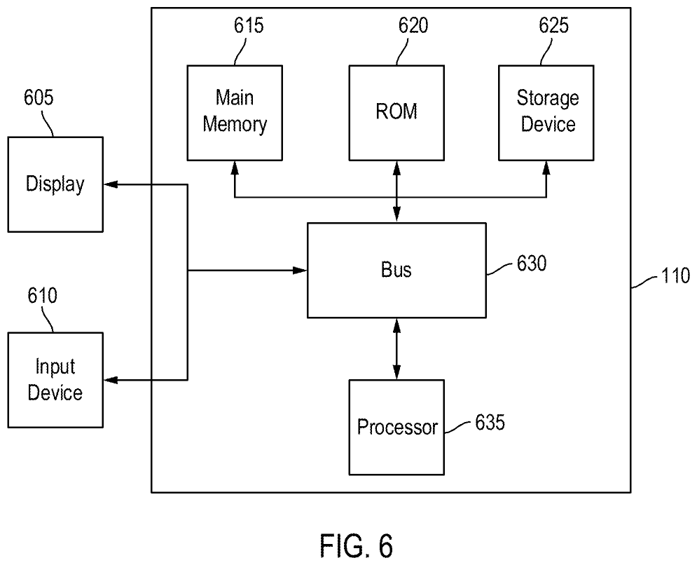

FIG. 6 depicts an example block diagram of the data processing system 110. The data processing system of FIG. 6 can provide an example data processing system architecture for the data processing system 120, the data processing system 470, of the BMS 465. The data processing system 110, e.g., a computer system or computing device, can include or be used to implement a data processing system or its components. The data processing system 110 includes at least one bus 630 or other communication component for communicating information and at least one processor 635 or processing circuit coupled to the bus 630 for processing information. The data processing system 110 can also include one or more processors 635 or processing circuits coupled to the bus for processing information. The data processing system 110 also includes at least one main memory 615, such as a random access memory (RAM) or other dynamic storage device, coupled to the bus 630 for storing information, and instructions to be executed by the processor 635. The main memory 615 can be used for storing information during execution of instructions by the processor 635. The data processing system 110 may further include at least one read only memory (ROM) 620 or other static storage device coupled to the bus 630 for storing static information and instructions for the processor 635. A storage device 625, such as a solid state device, magnetic disk or optical disk, can be coupled to the bus 630 to persistently store information and instructions.

The data processing system 110 may be coupled via the bus 630 to a display 605, such as a liquid crystal display, or active matrix display, for displaying information to a user such as a driver of the electric vehicle 105 or other end user. An input device 610, such as a keyboard or voice interface may be coupled to the bus 630 for communicating information and commands to the processor 635. The input device 610 can include a touch screen display 605. The input device 610 can also include a cursor control, such as a mouse, a trackball, or cursor direction keys, for communicating direction information and command selections to the processor 635 and for controlling cursor movement on the display 605.

The processes, systems and methods described herein can be implemented by the data processing system 110 in response to the processor 635 executing an arrangement of instructions contained in main memory 615. Such instructions can be read into main memory 615 from another computer-readable medium, such as the storage device 625. Execution of the arrangement of instructions contained in main memory 615 causes the data processing system 110 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, the systems described herein can be applied to multiple charging stations. In additional to, or instead of, determining charging assignments to power cabinets and dispensers that reduce a total length of time to charge a group of vehicles, the systems can determine charging assignments to various charging stations, the power cabinets of those charging stations, and the dispensers of those charging stations to reduce a total length of time to charge a group of vehicles. The systems that perform charging assignments as described herein can be applied to fleets of electric vehicles. For example, delivery vehicles, maintenance vehicles, semi-trucks, or other fleets of vehicles can be coordinated to generate charging assignments at one or multiple different charging stations, power cabinets, or dispensers that causes the fleet of vehicles to efficiently charge. Furthermore, vehicles that do not natively integrate with the systems describe can be retrofit with dongles or other computer systems that cause connect with application programming interfaces (APIs) of the systems described herein to integrate those vehicles with the systems discussed herein. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a data processing system comprising one or more processors, coupled with memory, to:
receive data indicating a characteristic of a vehicle;
determine, based on at least the characteristic of the vehicle, a length of time to charge the vehicle at a first dispenser and a length of time to charge the vehicle at a second dispenser;
assign the vehicle to the first dispenser based on the length of time to charge the vehicle at the first dispenser and the length of time to charge the vehicle at the second dispenser; and
transmit the assignment of the vehicle to the first dispenser to the vehicle.

2. The system of claim 1, comprising:
a power cabinet configured to share a total amount of power between the first dispenser and the second dispenser.

3. The system of claim 1, comprising:
a first power cabinet configured to provide power to the first dispenser; and
a second power cabinet configured to provide power to the second dispenser.

4. The system of claim 1, comprising:
the data processing system to:
receive data indicating a characteristic of a second vehicle;
determine, based on at least the characteristic of the vehicle and the characteristic of the second vehicle, a total time to charge the vehicle and the second vehicle;
assign the vehicle to the first dispenser and the second vehicle to the second dispenser that causes the total time to charge to be less than a threshold; and
transmit the assignment of the vehicle to the first dispenser to the vehicle and transmit the assignment of the second vehicle to the second dispenser to the second vehicle.

5. The system of claim 1, comprising:
the data processing system to:
determine, based on a characteristic of a second vehicle, a length of time to charge the second vehicle by the first dispenser and a length of time to charge the second vehicle by the second dispenser;
determine, based on the characteristic of the vehicle and the characteristic of the second vehicle, a plurality of total lengths of time to charge the vehicle and the second vehicle based on the length of time to charge the vehicle at the first dispenser, the length of time to charge the vehicle at the second dispenser, the length of time to charge the second vehicle at the first dispenser, and the length of time to charge the second vehicle at the second dispenser;
select a total length of time from the plurality of total lengths of time that minimizes the plurality of total lengths of time, the total length of time associated with the vehicle assigned to the first dispenser and the second vehicle assigned to the second dispenser; and
assign the vehicle to the first dispenser and the second vehicle to the second dispenser responsive to the selection.

6. The system of claim 1, comprising:
the data processing system to:
receive the characteristic of the vehicle that indicates a time to arrival of the vehicle at a charging station comprising the first dispenser and the second dispenser; and
determine, based on at least the time to arrival of the vehicle at the charging station, the length of time to charge the vehicle at the first dispenser and the length of time to charge the vehicle at the second dispenser.

7. The system of claim 1, comprising:
the data processing system to:
receive an indication of the vehicle charging at the first dispenser of a first power cabinet, the first power cabinet configured to share an available amount of power between the first dispenser and the second dispenser of the first power cabinet;
receive an indication of a time to arrival of a first vehicle at a charging station comprising the first power cabinet and a second power cabinet;
receive an indication of a time to arrival of a second vehicle at the charging station, wherein the time to arrival of the first vehicle is greater than the time to arrival of the second vehicle; and
assign the second vehicle to a power dispenser of the second power cabinet that is unused and the first vehicle to the second dispenser of the first power cabinet that is charging the vehicle.

8. The system of claim 1, comprising:
the data processing system to:
receive an indication of the vehicle charging at the first dispenser of a first power cabinet, the first cabinet configured to share a first half of an available amount of power of the first power cabinet with the first dispenser and a second half of the available amount of power with the second dispenser of the first power cabinet;
receive an indication of a first time to arrival of a first vehicle at a charging station comprising the first power cabinet and a second power cabinet;
receive an indication of a second time to arrival of a second vehicle at the charging station, wherein the first time to arrival is greater than the second time to arrival; and
assign the second vehicle to a power dispenser of the second power cabinet that is unused and the first vehicle to the second dispenser of the first power cabinet;
wherein the second power cabinet is configured to provide a total amount of power available to the second power cabinet to the second vehicle via the power dispenser of the second power cabinet; and
wherein the first power cabinet is configured to provide half of a total amount of power available to the first power cabinet to the first vehicle via the second dispenser of the first power cabinet.

9. The system of claim 1, comprising:
the data processing system to:
receive charging data from a power cabinet that conveys power to at least one of the first dispenser and the second dispenser, the charging data comprising a status of at least one of the first dispenser and the second dispenser; and
determine, based on the status of at least one of the first dispenser and the second dispenser, the length of time to charge the vehicle at the first dispenser and the length of time to charge the vehicle at the second dispenser.

10. The system of claim 1, comprising:
the data processing system to:
receive a first status indicating that the first dispenser is used by a particular vehicle to charge and a second status of the second dispenser indicating that the second dispenser is available to charge another vehicle; and
determine, based at least on the first status of the first dispenser and the second status of the second dispenser, the length of time to charge the vehicle at the first dispenser and the length of time to charge the vehicle at the second dispenser.

11. The system of claim 1, comprising:
the data processing system to:
receive an indication of a level of power available to be provided by one or more power cabinets to the first dispenser and the second dispenser; and
determine, based at least on the indication of the level of power, the length of time to charge the vehicle at the first dispenser and the length of time to charge the vehicle at the second dispenser.

12. The system of claim 1, comprising:
the data processing system to:
receive the characteristic of the vehicle, the characteristic of the vehicle comprising at least one of:
a state of charge of a battery pack of the vehicle; and
a charging curve of the battery pack of the vehicle;
determine the length of time to charge the vehicle at the first dispenser and the length of time to charge the vehicle at the second dispenser based on at least one of the state of charge of the battery pack of the vehicle and the charging curve of the battery pack of the vehicle.

13. The system of claim 1, comprising:
a second data processing system comprising one or more processors, coupled with memory, to:
establish a network connection with the vehicle;
collect, via the network connection, the data indicating the characteristic of the vehicle from the vehicle; and
transmit the data to the data processing system.

14. The system of claim 1, comprising:
the vehicle comprising:
a second data processing system comprising one or more processors, coupled with memory, to:
collect a data packet from a battery management system of a battery pack of the vehicle; and
transmit the data packet to the data processing system via at least an antenna of the vehicle.

15. The system of claim 1, wherein the characteristic of the vehicle includes at least one of:
a state of charge of a battery pack of the vehicle;
a charging curve of the battery pack of the vehicle
a state of health of the battery pack of the vehicle;
a time of day;
a temperature of the battery pack of the vehicle;
a navigation route of the vehicle; and
a level of traffic on the navigation route of the vehicle.

16. A method, comprising:
receiving, by a data processing system comprising one or more processors, coupled with
memory, data indicating a characteristic of a vehicle;
determining, by the data processing system, based on at least the characteristic of the vehicle, a length of time to charge the vehicle at a first dispenser and a length of time to charge the vehicle at a second dispenser;
assigning, by the data processing system, the vehicle to the first dispenser based on the length of time to charge the vehicle at the first dispenser and the length of time to charge the vehicle at the second dispenser; and
transmitting, by the data processing system, the assignment of the vehicle to the first dispenser to the vehicle.

17. The method of claim 16, comprising:
receiving, by the data processing system, data indicating a characteristic of a second vehicle;
determining, by the data processing system, based on at least the characteristic of the vehicle and the characteristic of the second vehicle, a total time to charge the vehicle and the second vehicle;
assigning, by the data processing system, the vehicle to the first dispenser and the second vehicle to the second dispenser that causes the total time to charge to be less than a threshold; and
transmitting, by the data processing system, the assignment of the vehicle to the first dispenser to the vehicle and transmit the assignment of the second vehicle to the second dispenser to the second vehicle.

18. The method of claim 16, comprising:
receiving, by the data processing system, the characteristic of the vehicle comprising at least one of:
a state of charge of a battery pack of the vehicle; and
a charging curve of the battery pack of the vehicle;
determining, by the data processing system, the length of time to charge the vehicle at the first dispenser and the length of time to charge the vehicle at the second dispenser based on at least one of the state of charge of the battery pack of the vehicle and the charging curve of the battery pack of the vehicle.

19. One or more memory devices configured to store instructions thereon that, when executed by one or more processors, cause the one or more processors to:
receive data indicating a characteristic of a vehicle;
determine, based on at least the characteristic of the vehicle, a length of time to charge the vehicle at a first dispenser and a length of time to charge the vehicle at a second dispenser;
assign the vehicle to the first dispenser based on the length of time to charge the vehicle at the first dispenser and the length of time to charge the vehicle at the second dispenser; and
transmit the assignment of the vehicle to the first dispenser to the vehicle.

20. The one or more memory devices of claim 19, the instructions causing the one or more processors to:
receive the characteristic of the vehicle, the characteristic of the vehicle comprising at least one of:
a state of charge of a battery pack of the vehicle; and
a charging curve of the battery pack of the vehicle;
determine the length of time to charge the vehicle at the first dispenser and the length of time to charge the vehicle at the second dispenser based on at least one of the state of charge of the battery pack of the vehicle and the charging curve of the battery pack of the vehicle.
